(19) United States
(12) Patent Application Publication
(10) Pub. No.: US 2002/0075161 A1
(43) Pub. Date: Jun. 20, 2002

(54) Universal remote control system

(76) Inventors: Mark J. Raffel, Port Washington, WI (US); Kenneth Seidl, Saukville, WI (US); Gregory Elliott, Port Washington, WI (US); David Vang, Adell, WI (US); Lee Raffel, Port Washington, WI (US)

Correspondence Address: MICHAEL BEST & FRIEDRICH, LLP, 100 E WISCONSIN AVENUE, MILWAUKEE, WI, 53202, US

(21) Appl. No.: 09/965,120

(22) Filed: Sep. 27, 2001

Related U.S. Application Data
(60) Provisional application No. 60/235,790, filed on Sep. 27, 2000.

(51) Int. Cl. H04M 11/00; G08C 19/00

(52) U.S. Cl. 340/825.69; 379/102.01

(57) ABSTRACT

A universal remote control system and apparatus capable of providing control for a piece of furniture having power lift, power recline, heat and/or massage functions. The universal remote control system also has the ability to remotely control most audio and/or video components, such as televisions, VCRs, CD players, and DVD players. The universal remote control system also includes a universal remote control unit having an input jack for receiving telephone signals, and control functions that allow the remote control unit to be used as a telephone.

### RELATED APPLICATIONS

Priority is claimed under 35 U.S.C. §119 to U.S. patent application Ser. No. 60/235,790.

### BACKGROUND OF THE INVENTION

The invention relates to remote control systems, and particularly to a universal remote control system and a universal remote control unit.

Remote control systems for electronic devices are well known. Most commonly, they are used to control televisions and videocassette recorders (VCRs). However, because of the prevalence of remote control systems for controlling the myriad of appliances commonly found, is not uncommon for an individual to have a number of remote control units that must be variously used to control audio and video and other appliances in use by the individual.

### SUMMARY OF THE INVENTION

The problem identified above can be exacerbated by the need to have access to a telephone or to use a control unit for controlling certain functions of the piece of furniture that the individual is sitting in or lying on. For example, in addition to the myriad of remote control units, the individual may wish to have a telephone. Additionally, many people have power lift or recline furniture units, and/or have furniture with built-in heat and massage features. Each of these functions must also have a control unit to allow the user to control the apparatus.

Accordingly, the invention provides a universal remote control unit that combines all of these functions. Specifically, the invention provides a universal remote control unit capable of providing control for a piece of furniture having power lift, power recline, heat and/or massage functions. The universal remote control unit also has the ability to be programmed to remotely control most audio and/or video components such as televisions, VCRs, compact disc (CD) players, digital video disc players (DVD), etc. The invention also includes a control unit having an input jack for receiving telephone signals, and control functions that allow the remote control unit to be used as a telephone.

Various other features and advantages of the invention are set forth in the following drawings, detailed description, and claims.

### BRIEF DESCRIPTION OF THE DRAWINGS

FIG. 1 illustrates a universal remote control system embodying the invention.

FIG. 2 is a table of heat control key states.

FIG. 3 is a table of stress meter resistance values and levels.

FIGS. 4A, 4B, and 4C illustrate pulse width modulation signals for a heat pad and massage motors.

FIGS. 5A, 5B, and 5C illustrate the operation of wave, pulse, and steady functions for the massage motors.

FIGS. 6A, 6B, and 6C illustrate the operation of intensity control keys for the massage motors.

FIGS. 7A, 7B, and 7C illustrate the operation of speed control keys for the massage motors.

FIGS. 8A, 8B, and 8C illustrate the operation of sensate control keys for the massage motors.

FIG. 9 is a table of massage control key inputs versus LED display outputs, heat pad outputs, and massage motor outputs.

FIG. 10 is a table of seating position control key inputs versus LED display outputs and lift actuator outputs.

### DETAILED DESCRIPTION OF THE INVENTION

Before one embodiment of the invention is explained in full detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including” and “comprising” and variations thereof herein is meant to encompass the items listed thereafter and equivalents thereof as well as additional items.

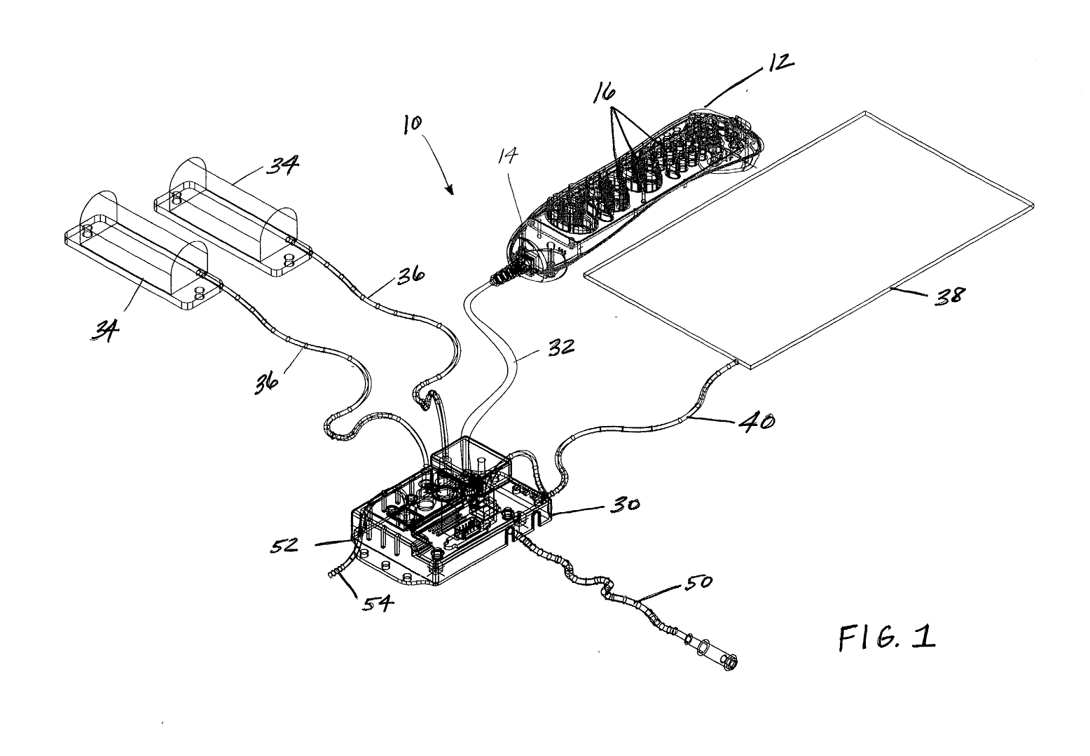

FIG. 1 illustrates a universal remote control system 10 embodying the invention. The universal remote control system 10 includes a universal remote control unit 12 coupled to a junction assembly 30 via a cable 32. However, the universal remote control unit 12 may also be wirelessly coupled to the junction assembly 30. The junction assembly 30 is used to physically couple some of the devices being controlled to the universal remote control unit 12. The universal remote control system 10 includes massage motors 34 coupled to the junction assembly 30 via cables 36. The universal remote control system 10 includes a heat pad 38 coupled to the junction assembly 30 via a cable 40. The universal remote control system 10 includes a power cable 50 adapted to be connected to a power supply (not shown). The universal remote control system 10 includes a telephone input 52 adapted to be connected to a telephone cable 54 and a telephone jack (not shown). However, the telephone input 52 maybe adapted for the transmission and receipt of conventional wireless communication technology signals, such as analog or digital cellular telephone signals.

The universal remote control unit 12 includes a housing 14. The housing 14 preferably has an elongated shape which can be easily held in the hand of a user. However, the housing 14 may be any shape suitable for the particular environment in which the universal remote control unit 12 will be used. For example, the housing 14 may be incorporated into the structure of a chair or couch (not shown). The housing 14 preferably includes a multi-color LED display (not shown). The LED display is used to indicate to the user various states of the universal remote control system 10. The housing 14 includes a transmitter (not shown) for transmitting signals to a remote location using conventional wireless communications technology, such as Infrared Data Association (IrDA) protocols, which is an industry standard group for the remote control of consumer electronic devices, such as TVs, VCRs, etc. The signals are received by devices located at the remote locations in order to control the devices.

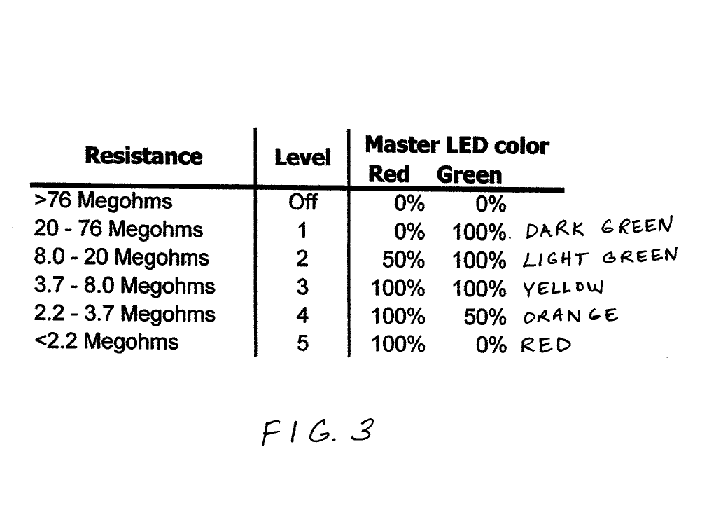

The housing 14 includes several controls 16. The controls 16 may be keys, buttons, switches, levers, scrolling devices, or any control device adapted to be manipulated by a user. The controls 16 may also be located on a touch-screen (not shown) incorporated into the housing 14. The controls 16 preferably include television controls, cable controls, satellite controls, VCR controls, and auxiliary controls. The controls 16 also preferably include massage and heat controls, seating position controls, and telephone controls. The controls 16 also preferably include a stress meter for measuring the skin resistance of the user's thumb or finger when placed on metal contacts on the sides of the universal remote control unit 12. The stress meter is operated according to the table in FIG. 3. Each of the controls 16 included in the universal remote control unit 12 will be further discussed below.

The television, cable, satellite, VCR, and auxiliary controls are used to control one or more televisions, cable systems, satellite dishes, VCRs, and auxiliary devices, such as stereo receivers, CD players, and DVD players. The controls include the following keys: a TV key, a CBL/SAT key, a VCR key, and an AUX key. Each of these controls keys selects the device to be controlled. The key that is pressed lights up momentarily to indicate the new device mode selection. The key that corresponds to the current mode also lights up momentarily when another key is pressed that controls the selected device. For example, if the TV key is pressed, the universal remote control unit 12 in TV mode and the TV key is lit up when pressed.

The television, cable, satellite, VCR, and auxiliary controls also include the following keys: a PWR key, several number pad keys (e.g., 0-9), a SLEEP key, a PLAY key, a STOP key, a REW key, a FF key, a MUTE key, a VOL+ key, a VOL− key, a CHAN+ key, a CHAN− key, a TV/VCR key, a GUIDE key, a SELECT key, and a CODE SEARCH key. The PWR key toggles the currently selected device on and off. The number pad keys enter a channel number for the currently selected device. The SLEEP key activates the sleep timer on devices with this feature. The PLAY, STOP, REW, and FF keys operates the play, stop, rewind, and fast-forward functions in VCR mode. These keys also work in AUX mode, depending on the device that is programmed for AUX mode. The MUTE key activates the mute function in TV mode. Depending on the device programmed for AUX mode, the MUTE key also operates that device. If the current mode is CBL/SAT or VCR, the MUTE key still operates the TV. The VOL+ and VOL− keys adjust the volume in TV mode. Depending on the device programmed for AUX mode, the VOL+ and VOL− keys also operate that device. If the current mode is CBL/SAT or VCR, the VOL+ and VOL− keys still operate the TV. The CHAN+ and CHAN− keys change the channel on the currently selected device. The TV, CBL/SAT, VCR, or AUX keys light up when the CHAN+ or CHAN− key is pressed to indicate which device is being operated by the CHAN+ or CHAN− key. The TV/VCR key activates the TV/VCR display toggle for the device programmed for VCR mode. If the device programmed for AUX mode is a second VCR, the TV/VCR key operates that device in AUX mode. If the current mode is TV or CBL/SAT, the TV/VCR key operates the VCR that is programmed for VCR mode. The GUIDE key activates the channel guide on the devices with this feature. The SELECT key serves as an “enter” key for devices equipped with a channel guide.

The CODE SEARCH key is used to program the universal remote. There are three ways to program the remote control. First, for manual code entry, the user presses the button that represents the device to be programmed (i.e., TV, CBL/SAT, VCR, or AUX). The user presses and holds the CODE SEARCH key until the master LED starts flashing red (e.g., for 3 seconds). The user then presses the number pad keys to enter the code for the device. Finally, the user presses the CODE SEARCH button again to set the current code.

Second, for a step search, the user presses the button that represents the device to be programmed (i.e., TV, CBL/SAT, VCR, or AUX). The user presses and holds the CODE SEARCH key until the master LED starts flashing red (e.g., for 3 seconds). The user presses the CHAN+ and CHAN− keys to step through all available codes. The device that the user is trying to program turns itself on or off when the user has selected the correct code. The user can also press the number pad keys to manually enter a code from which to start searching. Finally, the user presses the CODE SEARCH button to set the current code.

Third, for an auto scan search, the user presses the button that represents the device to be programmed (i.e., TV, CBL/SAT, VCR, or AUX). The user presses and holds the CODE SEARCH key until the master LED starts flashing red (e.g., for 3 seconds). The user presses and holds the CODE SEARCH key again until the master LED starts flashing green, instead of red. The system automatically scans all codes. When the particular device turns itself on or off, the user presses the CODE SEARCH key to set the current code.

The massage controls are used to control massage motors 34 and the heat pad 38. The massage controls include the following control keys: an ON/OFF key, a HEAT LO/OFF key, a HEAT HI/OFF key, a WAVE key, a PULSE key, a STEADY key, a ZONE 1 key, a ZONE 2 key, a SPEED+ key, a SPEED− key, an INTENSITY+ key, an INTENSITY− key, a SENSATE+ key, and a SENSATE− key. The Massage ON/OFF key turns the massage system functions on and off. When the massage system is on, the massage ON/OFF key is lit. This key is dark when the system is off. From an off state, pressing the massage ON/OFF key turns the system on. If the Massage ON/OFF key is pressed and held for at least 1.5 seconds from either an on or off state, the massage ON/OFF key flashes on and off for approximately 3 seconds, indicating that the system has changed from a 20-minute timer to a 30-minute timer. From an on state, if the massage ON/OFF key is pressed and held for less than 1.5 seconds, the system shuts off when the key is released. The massage system turns off automatically after 20 or 30 minutes of operation.

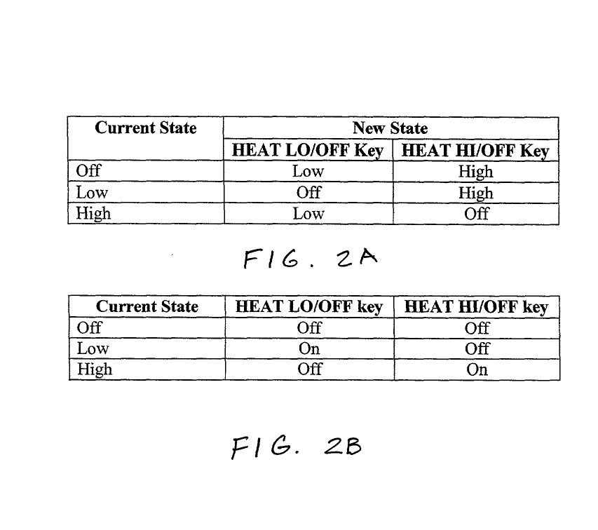

The HEAT LO/OFF and HEAT HI/OFF keys control the heat pad 38, as shown in the table in FIG. 2A. The HEAT LO/OFF and HEAT HI/OFF keys light up according to the table in FIG. 2B.

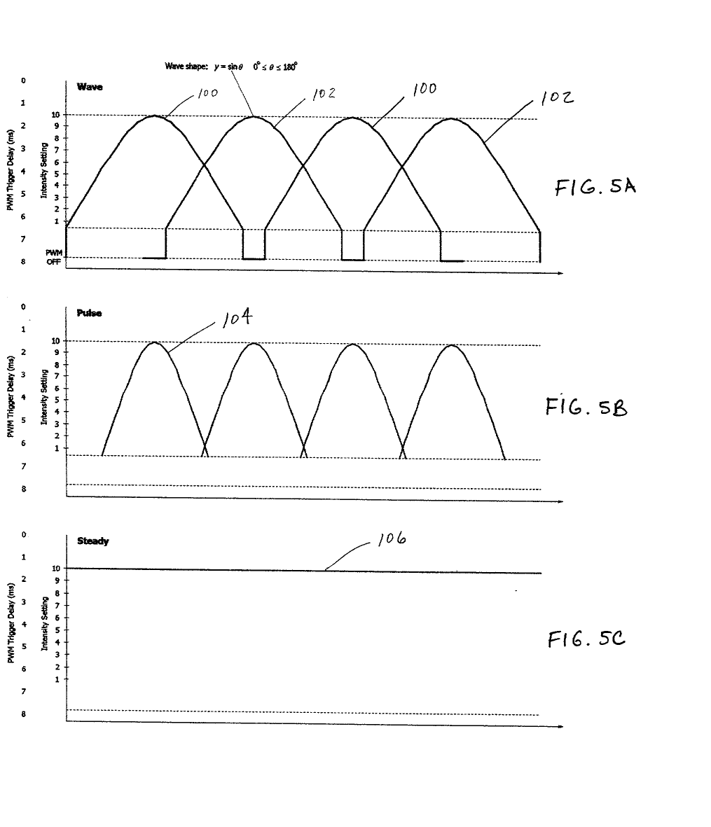

The WAVE key activates a wave massage function for the massage motors 34. The wave massage function operates as illustrated in FIG. 5A, which includes a first massage zone plot 100 and a second massage zone plot 102. The WAVE key lights up when pressed. If either the PULSE or STEADY keys were lit, they are turned off. The light patterns on the ZONE 1 and ZONE 2 keys alternate. When the ZONE 1 key is a maximum brightness, the ZONE 2 key is at minimum brightness, and vice versa. If the massage system is in an off state, the WAVE key has no effect.

The PULSE key activates a pulse massage function for the massage motors 34. The pulse massage function operates as illustrated in FIG. 5B, which includes a combined first and second massage zone plot 104. The PULSE key lights up when pressed. If either the WAVE or STEADY keys were lit, they is turned off. The light patterns on the ZONE 1 and ZONE 2 keys appear in phase. When one is at maximum brightness, so is the other. If the massage system is in an off state, the PULSE key has no effect.

The STEADY key activates a steady massage function for the massage motors 34. The steady massage function operates as illustrated in FIG. 5C, which includes a combined first and second massage zone plot 106. The STEADY key lights up when pressed. If either the WAVE or PULSE keys were lit, they are turned off. The ZONE 1 and ZONE 2 keys are lit steadily when both massage zones are active. If the massage system is in an off state, the STEADY key has no effect.

The ZONE 1 key toggles a first massage zone corresponding to one of the massage motors 34 on and off. The ZONE 1 key is dark when the first massage zone is off. The ZONE 1 key follows the patterns of the WAVE, PULSE, and STEADY functions if the first massage zone is on. If the massage system is in an off state, the ZONE 1 key has no effect. Turning the massage system on or changing the massage function resets the first massage zone to an on state.

The ZONE 2 key toggles a second massage zone corresponding to the other of the massage motors 34 on and off. The ZONE 2 key is dark when the second massage zone is off. The ZONE 2 key follows the patterns of the WAVE, PULSE, and STEADY functions if the second massage zone is on. If the massage system is in an off state, the ZONE 2 key has no effect. Turning the massage system on or changing the massage function resets the second massage zone to an on state.

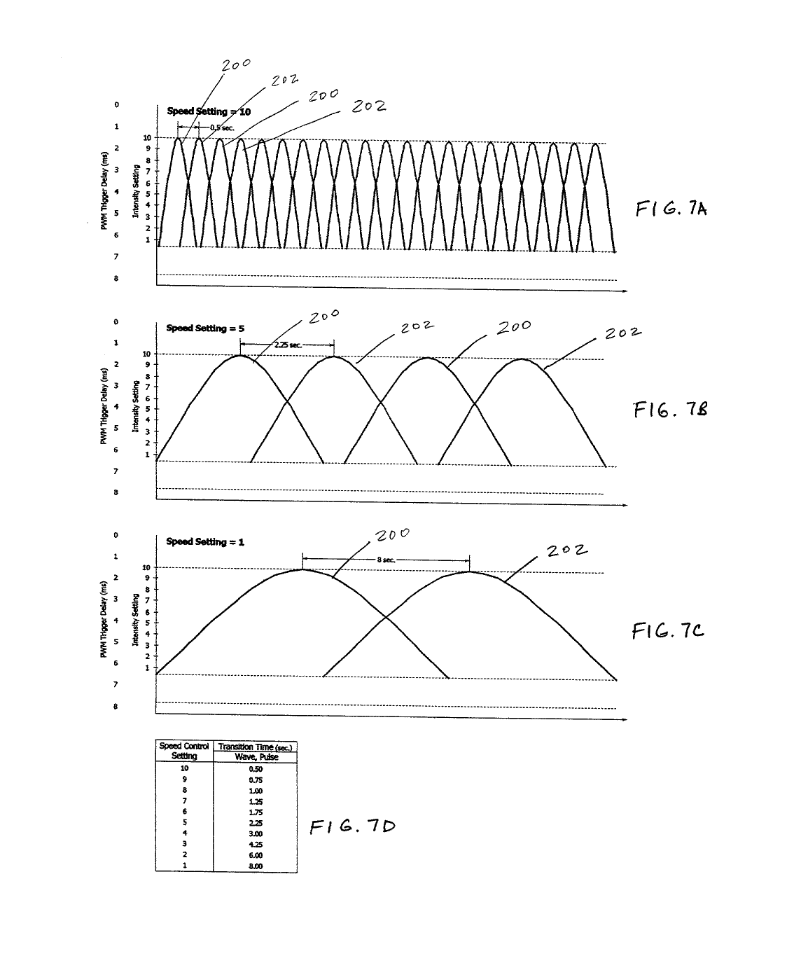

The SPEED+ and SPEED− keys control the speed of the massage motors 34 and the alternating or pulsating light patterns on the ZONE 1 and ZONE 2 keys. The speed control keys operate as illustrated in FIGS. 7A, 7B, and 7C, which include first massage zone plots 200 and second massage zone plots 202. Preferably, there are 10 speed settings, as listed the table in FIG. 7D. A press and release of the SPEED+ key increments the speed setting by one, while doing the same for the SPEED− key decrements it by one. Pressing and holding either of the speed control keys causes a repeated increase or decrease in the speed setting until the speed control key is released, or the limit is reached. For example, after the key is held for more than 0.5 seconds, the increase or decrease in the setting is repeated at a rate of 4 activations per second. Pressing SPEED+ when the current setting is at 10 has no effect. Also, pressing SPEED−when the current setting is at 1 has no effect. Pressing either of the speed control keys has no effect if the system is on the STEADY massage function, or the system is in an off state. A memory saves the user's preferred speed settings for each of the wave and pulse massage functions.

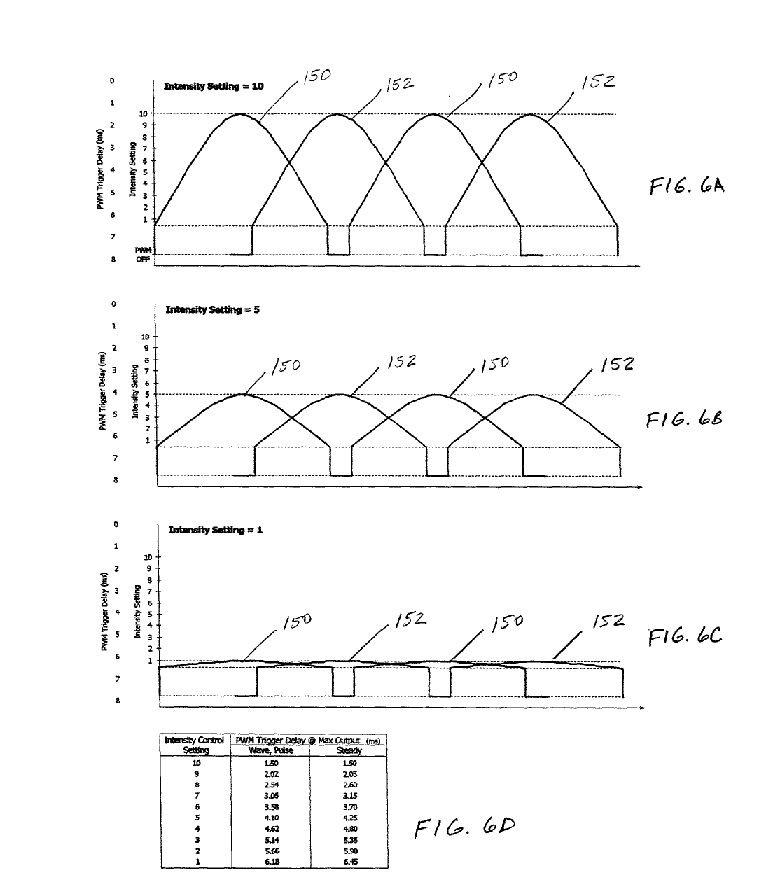

The INTENSITY+ and INTENSITY− keys control the power level to the massage motors 34. The intensity control keys operate as illustrated in FIGS. 6A, 6B, and 6C, which include first massage zone plots 150 and second massage zone plots 152. Preferably, there are 10 intensity settings, as listed in the table in FIG. 6D. A press and release of the INTENSITY+ key increments the intensity setting by one, while doing the same for the INTENSITY− key decrements it by one. Pressing and holding either of the intensity keys causes a repeated increase or decrease in the intensity setting until the intensity key is released, or the limit is reached. For example, after the key is held for more than 0.5 seconds, the increase or decrease in the setting is repeated at a rate of 4 activations per second. Pressing the INTENSITY− key when the current setting is at 1 has no effect, and pressing the INTENSITY+ key when the current setting is at 10 has no effect. If the massage system is in an off state, neither of the intensity keys has any effect. A memory saves the user's preferred intensity settings for each of the wave, pulse, and steady massage functions.

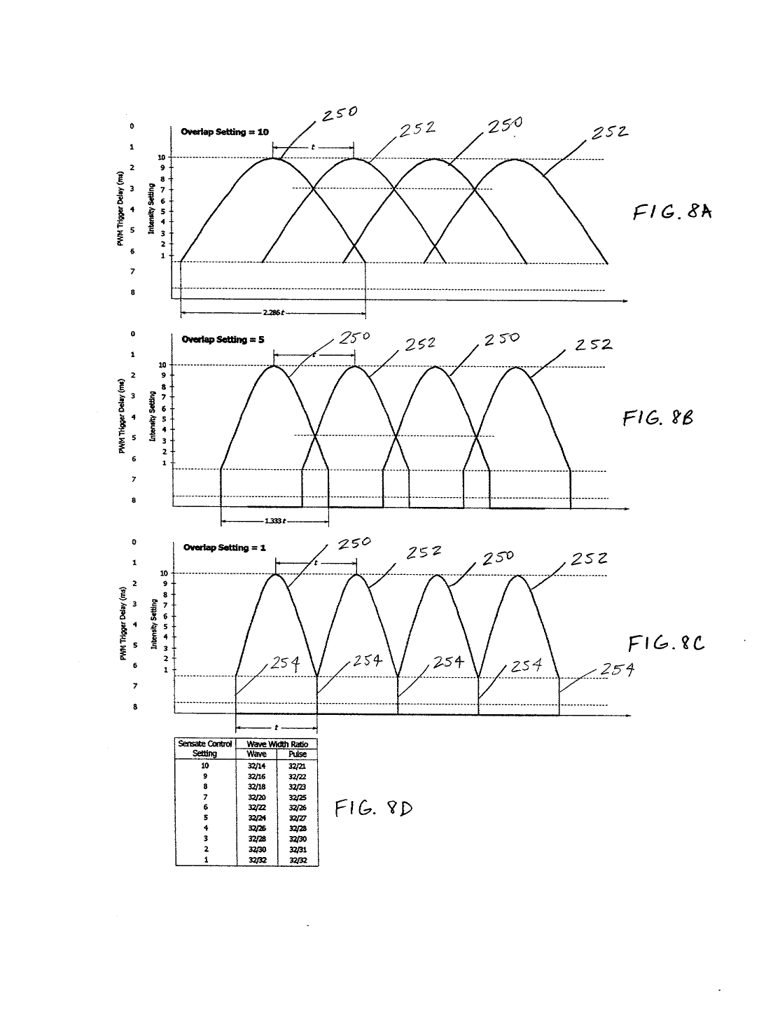

The SENSATE+ and SENSATE− keys control the amount of power overlap between the first massage zone and the second massage zone for the wave massage function, or the low point for the pulse massage function. The sensate control keys operate as illustrated in FIGS. 8A, 8B, and 8C, which include first massage zone plots 250, second massage zone plots 252, and combination first and second massage zone plots 254. Preferably, there are 10 sensate settings, as listed in the table FIG. 8D. A press and release of the SENSATE+ key increments the sensate setting by one, while doing the same for the SENSATE− key decrements it by one. Pressing and holding the key causes a repeated increase or decrease in the sensate setting until the key is released, or the limit is reached. For example, after the key is held for more than 0.5 seconds, the increase or decrease in the setting is repeated at a rate of 4 activations per second. Pressing SENSATE+ when the current setting is at 10 has no effect. Also, pressing SENSATE− when the current setting is at 1 has no effect. Pressing either of the sensate control keys has no effect if the system is on the steady massage function, or the system is in an off state. A memory saves the user's preferred sensate settings for each of the wave and pulse massage functions.

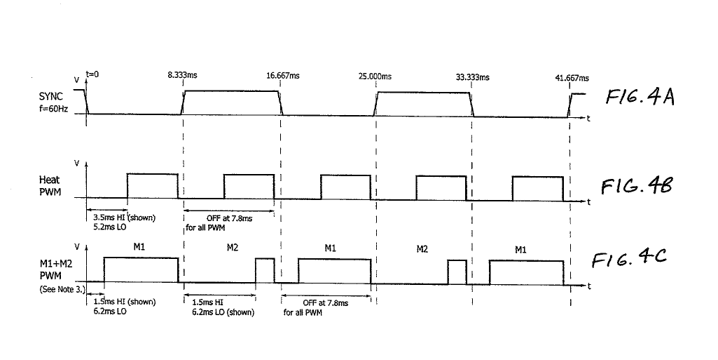

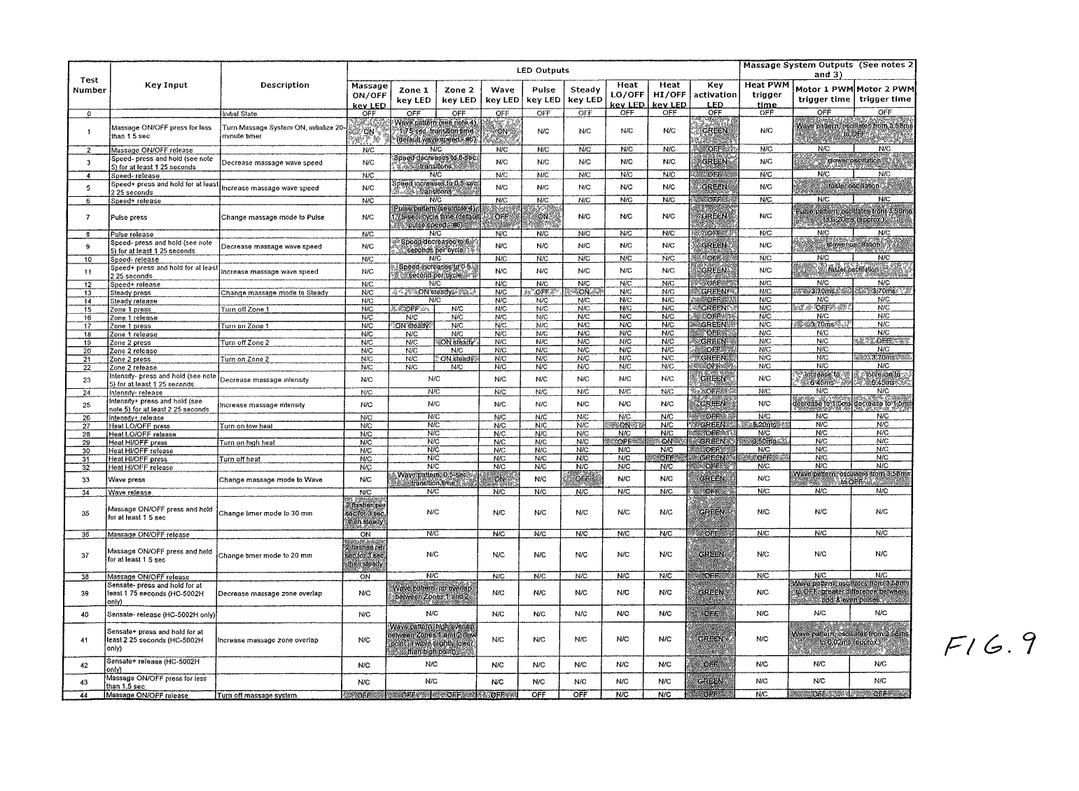

The table in FIG. 9 lists each possible massage control key input versus the outputs that are displayed on the LED display and the outputs of the heat pad 38 and the massage motors 34. Each row of the table represents a single test which is dependent on the conditions and results of the previous test. The specifications given for the pulse-width modulation (PWM) signals are for a frequency of 60 Hz. These values must be multiplied by 1.2 if the frequency of the circuit is 50 Hz. The PWM signal for the second massage zone motor is a single signal composed of “odd” and “even” pulses, as illustrated in FIGS. 4A, 4B, and 4C. The odd pulses coincide with the first massage zone, and occur when SYNC is low (as shown in FIG. 4A). The even pulses coincide with the second massage zone, and occur when SYNC is high (as shown in FIG. 4A). The pulse widths are proportional to the brightness of the ZONE 1 and ZONE 2 key LED's. The PWM signals shown in FIGS. 4B and 4C are intended to trigger triacs. The 7.8 milliseconds for cut-off ensures a logic zero when SYNC changes states (as shown in FIG. 4A), in order to prevent false triggering of the device on the next half-cycle. The massage motors 34 are driven with pulsed, direct current (DC), as shown in FIG. 4C. The first motor (M1) runs on the positive half-cycle of the alternating current (AC) line, and the second motor (M2) runs on the negative half-cycle of the AC line. Both motors M1 and M2 are driven by one triac, using the M1+M2 PWM signal (as shown in FIG. 4C). In comparison to the M1+M2 PWM signal shown in FIG. 4C, the SYNC signal shown in FIG. 4A is inverted.

The seating position control keys control a lift motor actuator for a lift or power-recline chair. The seating position control keys include the following control keys: an UP key, a DOWN key, a RECLINE key, and a CLOSE key. Each seating position control key is lit when pressed and when the mechanism is moving. Normally the mechanism only moves while the seating position control key is being held down. If the seating position control key is double-clicked, the system enters an auto-run mode and the mechanism moves for 30 seconds without the seating control key being held. If another seating position control key is pressed during the 30-second auto-run mode, the mechanism stops and the system returns to a normal mode.

The universal remote control system 10 may include a safety device associated with the seating position control keys. If the safety device is activated, it sends a ground signal to the universal remote control unit 12. If the mechanism was not being used, the safety signal is ignored. Otherwise, the system then activates the UP or RECLINE functions. This is active as long as the ground signal is present, and for 5 seconds after it clears. The UP or RECLINE key is flashing quickly. During that time, pressing either key cancels the auto-run. After the safety auto-run, the lift/recline system goes into a locked mode, and the mechanism stops. The locked mode can be toggled on and off by pressing both the UP key and the DOWN key or the CLOSE key and the RECLINE key simultaneously. When the locked mode is turned on, both keys flash for 3 seconds to indicate that the locked mode is enabled. When the locked mode is on, pressing either key causes both keys to flash for 3 seconds, indicating that the command is ignored. The lift mechanism is not be activated in the locked mode.

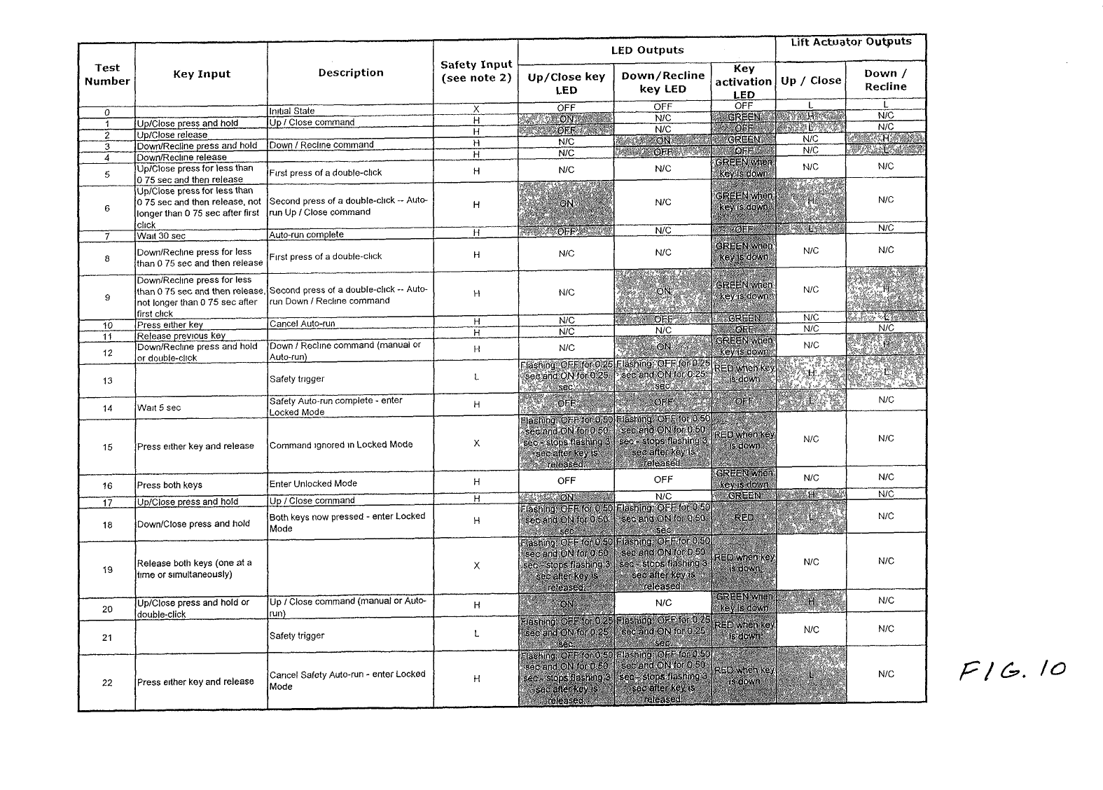

The table in FIG. 10 lists the seating position control key inputs versus the LED outputs and the lift actuator outputs for the chair being controlled. Each row of the table represents a single test which is dependent on the conditions and results of the previous test. The lift actuator outputs and safety signal inputs are TTL-compatible digital logic signals (i.e., L=low/zero volts, H=high/5 volts, X=do not care).

The telephone controls include the following telephone control keys: a PHONE key, several number pad keys (e.g., 0-9, *, #), a FLASH key, a REDIAL key, a MUTE key, a VOL+ key, a VOL− key, and a SELECT key. The PHONE key turns the phone system on and off. From an off state, pressing the PHONE key turns the phone on. The PHONE key is lit to indicate that the phone is online. If the phone line is connected, a dial tone is heard through the earpiece, and the user can use the control like an ordinary telephone. Pressing the PHONE key again hangs the phone up, and the PHONE key is dark, indicating that the phone is offline. The PHONE key is also used to answer an incoming call.

The number pad keys operate the same as an ordinary telephone when the phone is on. If the phone is off, the telephone control keys may operate other functions of the universal remote control unit 12. The FLASH key works like the flash key on an ordinary telephone. For example, it can be used to switch between multiple calls for users subscribed to call waiting or similar services. The REDIAL key dials the most recent phone number that was previously dialed. The MUTE key turns off the microphone, so that the party on the other end of the telephone conversation cannot hear you. Pressing the MUTE key again re-enables the microphone. The VOL+ and VOL− keys adjust the earpiece volume. The SELECT key toggles the functions of the MUTE and VOL+ and VOL− keys between the phone and the universal remote control.

Various other features and advantages of the invention are set forth in the following claims.

What is claimed

1. A universal remote control system comprising:
a junction assembly;
at least one of a seating position motor, a massage motor, and a heat pad coupled to the junction assembly;
a universal remote control unit coupled to the junction assembly, the universal remote control unit including
a housing,
a plurality of controls coupled to the housing, the plurality of controls including
at least a one of a television control, a cable control, a satellite control, a video cassette recorder control, and an auxiliary control, and
at least a one of a seating position control, a massage control, and a heat control; and
a transmitter coupled to the housing for transmitting signals corresponding to the plurality of controls to a remote location.

2. The universal remote control system of claim 1 wherein the universal remote control unit includes telephone controls allowing use of the universal remote control unit as a telephone.
